(19) United States
(12) Patent Application Publication
(10) Pub. No.: US 2009/0133341 A1
(43) Pub. Date: May 28, 2009

(54) WINDOW INSULATION APPARATUS AND METHOD OF ATTACHING

(76) Inventor: Nicholas G. Kontos, Warren, OH (US)

Correspondence Address: PEARNE & GORDON LLP, 1801 EAST 9TH STREET, SUITE 1200, CLEVELAND, OH, 44114-3108, US

(21) Appl. No.: 11/944,718

(22) Filed: Nov. 26, 2007

(51) Int. Cl. E06B 3/67; E06B 3/28; E06B 3/66; E06B 9/00; E06B 3/667

(52) U.S. Cl. 52/202; 160/107; 52/506.05; 52/747.1; 52/787.11

(57) ABSTRACT

An insulated window apparatus includes a body having a face surface and top, bottom, and opposed side surfaces coupled to the face surface. Each of the top, bottom, and opposed side surfaces are coupled to a portion of the face surface and to each other to define a chamber. An insulative member is provided. A lip is formed on at least one of the top, bottom, and opposed side surfaces and extends away from the chamber. A stud is adapted to be coupled to a window frame. A connector is adapted to couple to the stud and have securement means adapted to engage the body for retaining the body in abutment with the window. In one example, the securement means includes a resilient arm adapted to engage the lip. A method of assembling the insulated window apparatus to a window having a window frame is also provided.

### CROSS-REFERENCE TO RELATED APPLICATIONS

Not Applicable.

### FIELD OF THE INVENTION

The present invention relates generally to an insulation apparatus, and more particularly, to a window insulation apparatus and a method of attaching it to a window.

### BACKGROUND OF THE INVENTION

Buildings, homes, and the like often include a plurality of windows for providing light and/or fresh-air. Additionally, the windows provide a measure of thermal insulation from the outside environment. However, most windows are formed of glass, and many have only a single layer of thickness that may present an undesirably high rate of heat transfer, resulting in increased heating and cooling costs. This can be especially problematic in industrial buildings, such as factories, warehouses, and the like, which can include a multitude of windows surrounding relatively large rooms that are expensive to heat and cool.

A heavily insulated window of moderate size and complexity may cost a prohibitive amount of money, due particularly to the large amount of skilled labor necessary in its production. Thus, heavily insulated windows are especially cost prohibitive in industrial buildings having multitudes of windows. Furthermore, glass windows have disadvantages associated with the mechanical properties of the glass. The glass may have low impact resistance, a particular problem in the case of windows having deep cuts with sharp internal corners. Also, decorative windows formed as composites of multiple glass panels cannot be used in many architectural applications because building codes require the use of safety glass windows in entry doors and load bearing walls. Accordingly, there is a need for an improved insulative window apparatus.

### BRIEF SUMMARY OF THE INVENTION

Accordingly, it is an aspect of the present invention to obviate problems and shortcomings of conventional window insulation apparatuses.

To achieve the foregoing and other aspects and in accordance with the present invention, an insulated window apparatus is provided, including a face surface and top, bottom, and opposed side surfaces coupled to the face surface. Each of the top, bottom, and opposed side surfaces are coupled to a portion of the face surface and to each other to define a chamber. An insulative member is provided, and a lip is formed on at least one of the top, bottom, and opposed side surfaces. The lip extends away from the chamber.

To achieve further aspects and in accordance with the present invention, a method of assembling an insulated window apparatus to a window having a window frame is provided. The method includes the steps of providing an insulated window unit, including a face surface and top, bottom, and opposed side surfaces coupled with the face surface, and a lip formed on at least one of the top, bottom, and opposed side surfaces. The method also includes the step of providing a stud and a connector configured to be coupled to the stud, with the connector including a resilient arm. The method also includes the steps of coupling the stud to the window frame, coupling the connector to the stud, locating the insulated window unit in a covering relationship over the window and adjacent to the window frame, and engaging the lip of the insulated window unit with the arm of the connector to thereby retain the insulated window apparatus in abutment with the window.

To achieve still further aspects and in accordance with the present invention, an insulated window apparatus assembly adapted for installation over a window having a window frame is provided. The insulated window apparatus assembly includes a body including a face surface and top, bottom, and opposed side surfaces coupled with the face surface to define a recess, with the body having a first outer perimeter. An insulative member is provided having a second outer perimeter, with the second outer perimeter being greater than the first outer perimeter. A stud is adapted to be coupled to a window frame. A connector is adapted to couple to the stud and having securement means adapted to engage the body for retaining the body in abutment with the window.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 illustrates a front view of an array of windows with example insulated window apparatuses attached to the windows in accordance with an aspect of the present invention;

FIG. 2 illustrates a front view of an example insulated window apparatus in accordance with an aspect of the present invention;

FIG. 2A is similar to FIG. 2, but illustrates another example insulated window apparatus in accordance with another aspect of the present invention;

FIG. 3 is similar to FIG. 2, but illustrates a top view;

FIG. 4 illustrates a sectional view along line 4-4 of FIG. 3;

FIG. 5A illustrates a front view of an example connector in accordance with another aspect of the present invention;

FIG. 5B is similar to FIG. 5A, but illustrates another example connector in accordance with another aspect of the present invention;

FIG. 6 is similar to FIG. 5A, but illustrates a top view;

FIG. 7 is a top detail view of an example method of attaching an insulated window apparatus to a window in accordance with another aspect of the present invention;

FIG. 8 is similar to FIG. 7, but shows another step in the example method;

FIG. 9 is similar to FIG. 7, but shows another step in the example method;

FIG. 10 is similar to FIG. 7, but shows another step in the example method;

FIG. 11 is similar to FIG. 7, but shows another step in the example method;

FIG. 12 illustrates a top view of another example connector in accordance with another aspect of the present invention; and

FIG. 13 is similar to FIG. 12, but illustrates a side view.

### DESCRIPTION OF EXAMPLE EMBODIMENTS

Example embodiments that incorporate one or more aspects of the present invention are described an illustrated in the drawings. These illustrated examples are not intended to be a limitation on the present invention. For example, one or more aspects of the present invention can be utilized in other embodiments and even other types of devices.

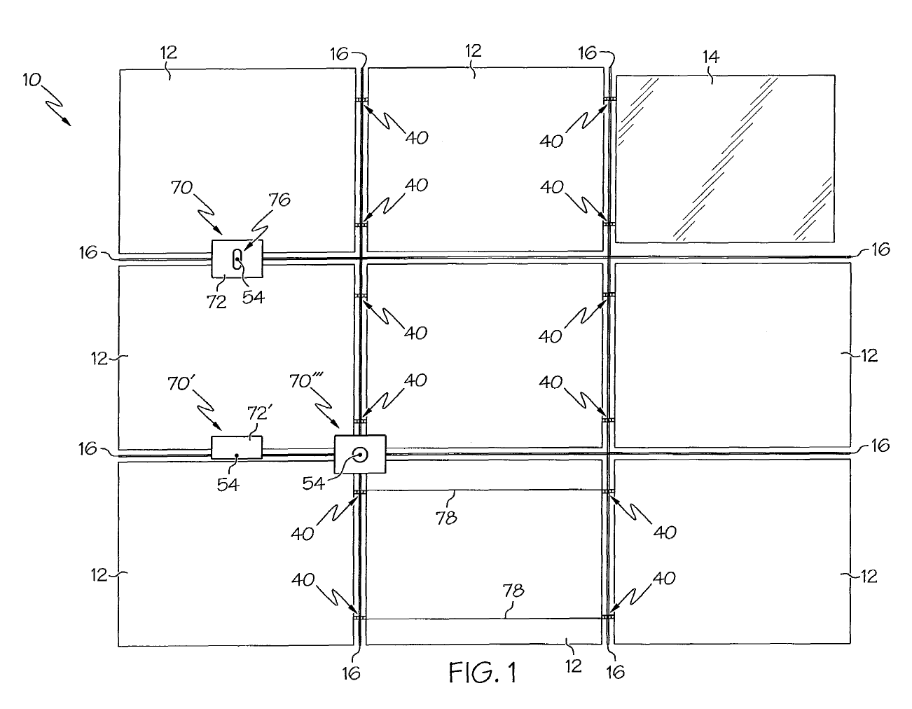

Turning to the shown example of FIG. 1, an array of windows 10 are illustrated with an example insulated window apparatus 12 attached to each of the windows 14, save for one, in accordance with an aspect of the present invention. That is, for clarity, one window 14 (i.e., the upper right corner window) is illustrated without an insulated window apparatus 12 attached thereto. Conversely, each of the other windows 14 are hidden by the insulated window apparatus 12 attached thereto. It is to be appreciated that although the insulated window apparatuses 12 are illustrated and described herein with reference to an array of windows 10, it is to be appreciated that the insulated window apparatus 12 can be used with various numbers of windows, including only a single window. Additionally, though shown as having only a single insulated window apparatus 12 in covering relationship with a single window 14, various numbers of insulated window apparatuses 12 can be used with each window 14. Further, though the windows 14 are each described as being formed of glass, the window insulation apparatus 12 can be utilized with windows 14 having various other materials (e.g., plastic, metal, wood, etc.).

The array of windows 10 of FIG. 1 are illustrated in a manner representative of a generic array of windows as may be found in an industrial building, such as a factory, warehouse, etc. In such an array 10, a plurality of windows 14 are often arranged in a generally rectilinear array having a correspondingly arranged window frame 16. The window frame 16 can generally surround each window 14 on all sides, as shown with the center window, or can bound only a portion of each window 14 as shown with the remaining windows 14. It is to be appreciated that various window frames 16 can be adapted to surround various portions of the windows 14. Additionally, the window frame 16 can be one continuous structure, or can be formed of various interconnected members. Further still, the window frame 16 can be formed of various generally rigid materials, such as metal, wood, plastic, stone, etc.

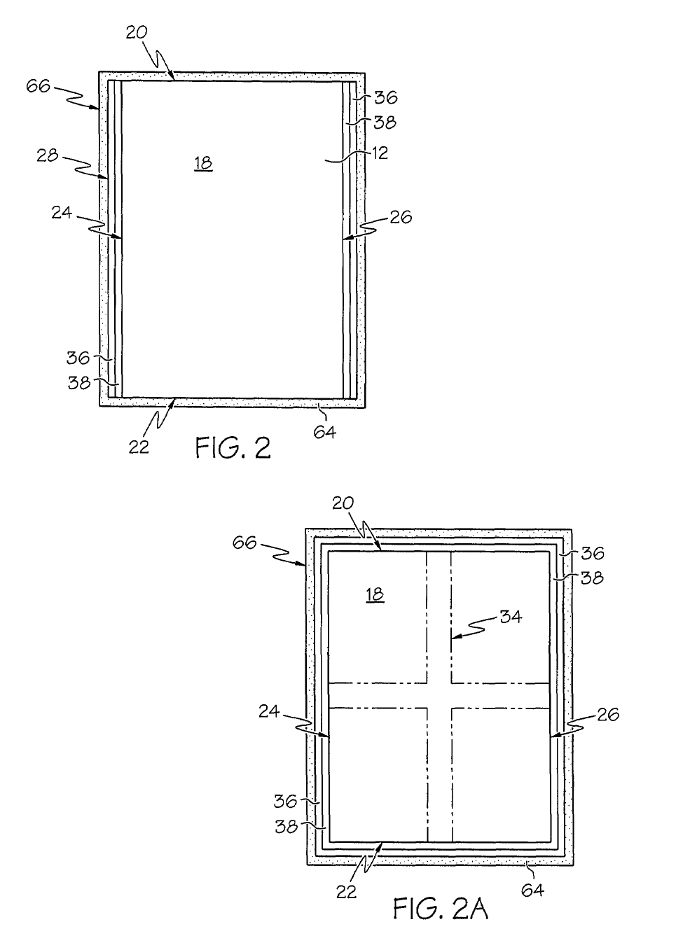

Turning now to FIGS. 2-4, an example insulated window apparatus 12 is illustrated. Though shown as having a generally rectilinear geometry, it is to be appreciated that the insulated window apparatus 12 can have various other geometries, such as, for example, circular, square, triangular, elliptical, polygonal, irregular, etc. The insulated window apparatus 12 includes a face surface 18 and top 20, bottom 22, and opposed side surfaces 24, 26 formed with the face surface 18. Each of the top 20, bottom 22, and opposed side surfaces 24, 26 are can be coupled to (attached to or formed with) a portion of the face surface 18 and to each other so as to form a generally continuous, monolithic body 28 defining a generally hollow interior chamber 30 or recess therein. The interior chamber 30 or recess can remain empty so as to form an insulating air pocket, or can be filled partially or completely with an insulative material 32 (shown in phantom), such as foam, a trapped-air-pocket material (e.g., bubble-wrap or the like), fiberglass, fabric, etc. In addition or alternatively, the chamber 30 or recess can be filled with a fluid material, such as a gel, liquid, or even a gas. It is to be appreciated that where a fluid material is used, corresponding structure can be used to retain the fluid material and inhibit leaks, permit filling/draining, etc. In addition or alternatively, the insulative material 32 can have a reflective coating so as to aid in reflecting light and/or heat loss, though various other coatings are also contemplated. Though shown as generally uniform, the various surfaces 18-26 and corresponding side walls can have various thicknesses, and as such the interior chamber 30 or recess can have a corresponding geometry. In addition or alternatively, though not shown, the insulated window apparatus 12 can further include support structure, stiffeners, ribs, or the like located within the interior chamber 30 or recess to provide relatively greater structural stability.

In addition or alternatively, the body 28 can include one or more projections 33, 33′ or the like located within the interior chamber 30 for contact with the insulative material 32. The projections 33, 33′ can have various sizes and geometries, and can be located variously within the interior chamber 30. In one example, the projections 33 can be attached to or formed with the interior of the front face 18. In another example, the projections 33′ can be attached to or formed with the interior of any of the other faces, such as the top or bottom faces 20, 22. As stated, the projections 33, 33′ can be formed with the body 28, or can be attached thereto using various methods, such as fasteners, adhesives, welding, hook-and-loop style fasteners, mechanical clips, interference fits, or the like, etc. The projections 33, 33′ can be configured to retain the insulative material 32 in a particular location, and/or can be configured to provide a spacing gap for the insulative material 32 relative to the interior chamber 30. For example, the projections 33, 33′ can be configured to provide an air gap of approximately ¾″ on either or both sides of the insulative material 32. As such, the projections 33, 33′ can be configured to merely abut the insulative material 32, and/or can be configured to be coupled with the insulative material 32. In addition or alternatively, where an insulative member 64 is used between the insulated window apparatus 12 and the window 14, as described herein, one or more of the projections 33, 33′ can be configured to abut and/or be coupled to the insulative member 64 for retention, spacing, etc.

The body 28 of the window insulation apparatus 12 can be formed of various generally rigid materials. In one example, a thermoplastic material can be used, such as polypropylene, polystyrene, polycarbonate, or the like, and can be formed using various molding techniques, such as injection molding, blow molding, casting, coating, extrusion, rotational molding, thermoforming (e.g., vacuum thermoforming), transfer molding, etc. Additionally, the material used can have various intrinsic, engineered, or added properties to provide additional features to the insulated window apparatus 12. In one example, any or all of the body 28 can be formed of a light permeable material. For example, the face surface 18 can be formed of a light permeable material that can permit the passage of light, wholly (e.g., transparent) or partially (e.g., translucent), though any or all of the other faces 20-26 can also be light permeable. As a result, although the insulated window apparatus 12 is arranged in a covering relationship over a window 14, light can still be permitted to enter and provide illumination to the building. It is to be appreciated that if an insulative material 32 is also used, it may similarly be light permeable to permit light to illuminate the building. In another example, the insulated window apparatus 12 can also be opaque, so as to inhibit the passage of light into the building.

The material forming the body 28 can also have various other intrinsic, engineered, or added properties. For example, the material can have various colors, UV inhibitors, anti-bacterial chemicals, embedded structural elements (e.g., embedded structural fibers, etc.), embedded visual-appearance elements (e.g., embedded elements adapted to alter the visual appearance of the material), etc. In another example, the body 28 can have various coatings to provide additional performance features. For example, the body 28 can be coated with a reflective coating to reflect light, a one-way mirror coating, UV protective coating, color coating, structural coating, visual-appearance coating, magnetic coating, anti-fog coating, etc. It is to be appreciated that the body 28 can also be formed of various other materials (e.g., metals, hard rubbers, glass, wood, etc.) using various other suitable manufacturing techniques. Such other materials can similarly have various intrinsic, engineered, or added properties or coatings. In yet another example, portions of the insulated window apparatus 12 can include decorative features 38 that are formed with or applied thereto. For example, as shown in FIG. 2A, a decorative feature 34 (shown in phantom) or the like can be formed with or applied to the face surface 18 (or even the interior of the body 28, such as within the chamber 30 or recess) that simulates a conventional window grille. It is to be appreciated that various other decorative/aesthetic features can also be utilized, such as images, a stained-glass effect, a glass-block effect, louvers, reflectors, etc. The decorative feature 34 can be formed with the body 28, such as formed during an injection molding operation, or can be applied to the body 28 in various manners, such as by way of a coating, painting, adhesives, etc., including the application of various structures thereto.

The insulated window apparatus 12 can also include structure to facilitate mounting and retention of the apparatus 12 on a window 14. In one example, the window apparatus 12 can include a lip 36 coupled to (attached to or formed with) at least one of the top surface 20, bottom surface 22, and/or opposed side surfaces 24, 26 for engagement with engagement means, as will be described more fully herein. For example, as shown in FIG. 2, a pair of lips 36 can be disposed on each of the side surfaces 24, 26. In another example, as shown in FIG. 2A, the lip 36 can be disposed on each of the top 20, bottom 22, and opposed side surfaces 24, 26 so as to extend generally continuously around the outer perimeter of the body 28. It is to be appreciated that one or more lips 36 can be arranged variously about the body 28 and can include various shapes and lengths. For example, as shown, each lip 36 extends generally along the whole length of a side of the body 28. However, it is to be appreciated that the lip 36 can also extend along various lengths of a side, and can even include a plurality of lips 36 arranged in a pattern, array, or even randomly along a side of the body 28. Additionally, though described herein as being formed with at least one of the top 20, bottom 22, and opposed side surfaces 24, 26, the lip 36 can also be a separate element removably or non-removably attached thereto.

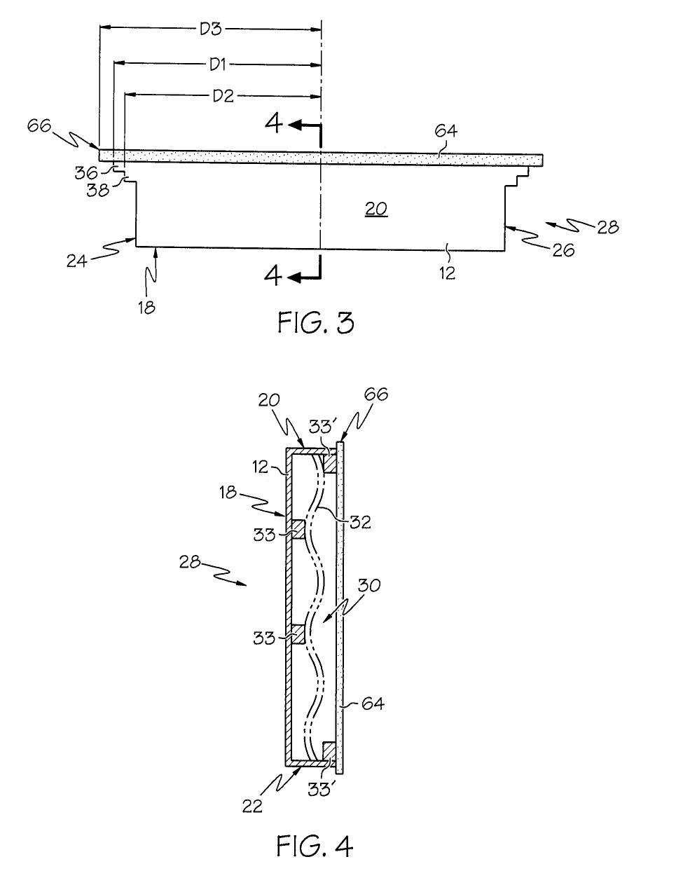

The lip 36 can have various geometries. For example, as shown in FIG. 3, the lip 36 can have a generally flat geometry, coupled to or formed with at least one of the top 20, bottom 22, and opposed side surfaces 24, 26, that extends away from the chamber 30 or recess. That is, as shown, the lip 36 can be formed with one of the side surfaces 24, 26 and can project outwardly away from the body 28 (e.g., away from the chamber 30 or recess). In another example, as shown in FIG. 3, the lip 36 can include a generally stepped geometry formed by two or more adjacent lips 36, 38. For example, a first of the lips 36 can extend a first distance D1 away from the chamber 30 or recess (e.g., with reference to a fixed point within the chamber 30 or recess, such as the center or edge), and a second of the lips 38 can extend a second distance D2 away from the chamber 30 or recess, with the first distance D1 being greater than the second distance D2. Thus, the difference between the first and second distances D1, D2 can provide the generally stepped geometry. Additionally, as described above, either or both of the first and second lips 36, 38 can extend partially or completely around the outer perimeter of the body 28, and/or can include a plurality of lips 36, 38 arranged variously about the body 28.

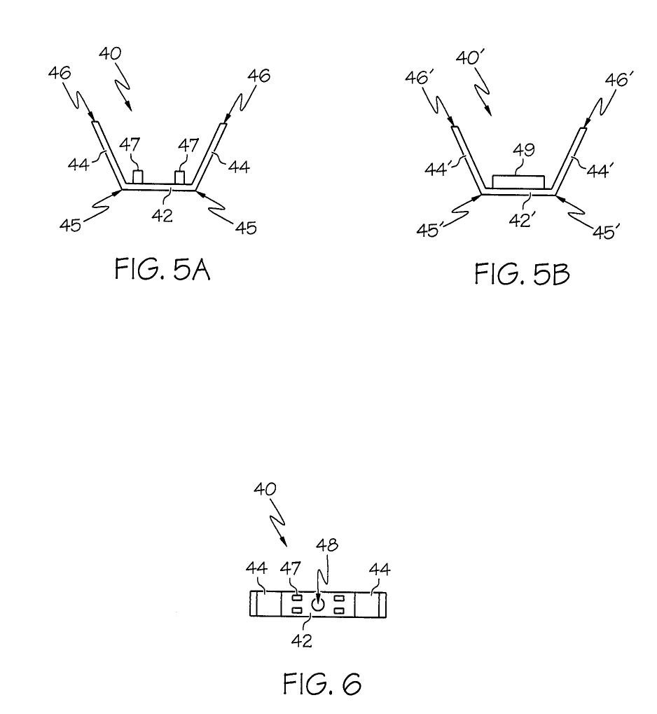

Turning now to the examples shown in FIGS. 5A, 5B, and 6, an example connector 40 is illustrated for retaining the insulated window apparatus 12 in abutment with the window 14. In one example, the connector 40 can include a central frame 42 and securement means for engaging the insulated window apparatus 12. In one example, as shown, the securement means can include one or more resilient arms 44 attached to the central frame 42 and adapted to engage the lip 36 (or lips 36, 38) of the insulated window apparatus 12. The resilient arms 44 can be attached to or formed with the central frame 42 at a proximal end 45, while a distal end 46 of each arm 44 extends a distance away therefrom. Thus, the distal end 46 of each arm 44 can be resiliently pivotable relative to the central frame 42 about the proximal end 45 (e.g., elastic deformation). In addition or alternatively, the distal end 46 of each arm 44 can have various geometries, such as a generally flat geometry or even a chamfered geometry, as shown in FIGS. 5A-5B, so as to provide a better “bite” to retain the insulated window apparatus 12. Further, the connector 40 can also include a hole 48 extending through the central frame 42 to facilitate attachment to a window frame 16, as will be discussed more fully herein.

The connector 40 can be formed of various materials. In one example, the connector 40 can be formed of a thermoplastic material using various thermoplastic manufacturing techniques, such as injection molding or any other technique discussed herein. The connector 40 can also be formed of various other materials, such as metal, hard rubber, etc. that can provide resiliency to the arms 44. For example, where the connector 40 is formed of metal, various metal manufacturing techniques can be used (e.g., casting, stamping, bending, cold-working, hot-working, etc.) In other examples, the connector 40 can be formed of various materials that can

The connector 40 can also include additional features. For example, as shown in FIGS. 5A and 6, the connector 40 can include one or more tangs 47 or tangs coupled to the central frame 42 and adapted to capture and/or retain a portion of the window frame 16. For example, where two or more tangs 47 are used, as shown, the window frame 16 can be captured therebetween to facilitate alignment of the connector 40 with the window frame 16, and inhibit skewing or the like. In another example, one or more of the tangs 47 can be resiliently biased inwardly so as to resiliently retain the connector 40 on the window frame 16 by way of friction, an interference fit, or the like. In another example, as shown in FIG. 5B, the connector 40′ can include a standoff 49 or of the spacing structure adapted to provide some distance between the connector 40′ and the window frame 16. For example, where an insulative member 64 is used between the insulated window apparatus 12 and the window 14, as described herein, the standoff 49 can provide additional spacing to compensate for the additional thickness of the insulative member 64. The tangs 47 and the standoff 49 can be formed with or even attached to the connector 40, 40′ in various manners, including molding, stamping, forming, adhesives, fasteners, welding, brazing, soldering, etc. It is to be appreciated that a connector 40, 40′ can include either or both of the tangs 47 and/or the standoff 49.

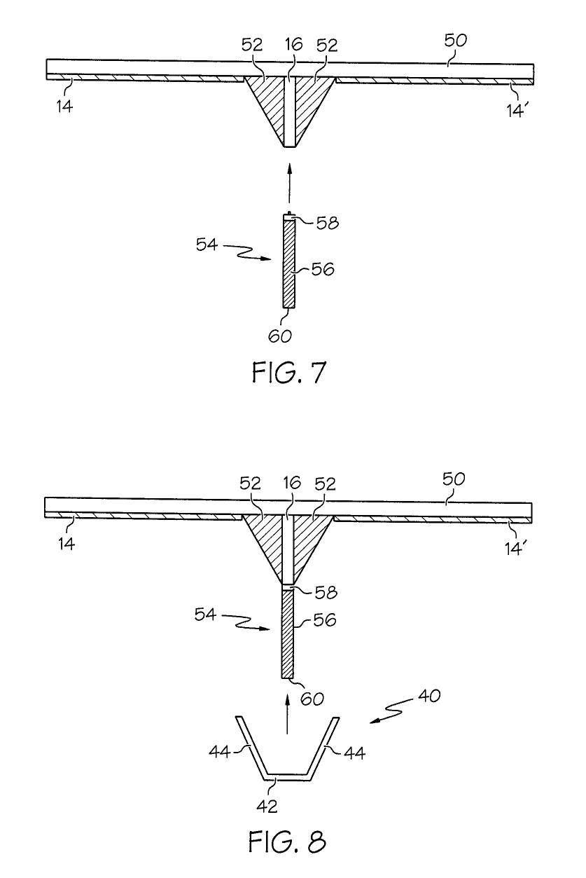

Turning now to FIGS. 7-11, an example method of assembling the insulated window apparatus 12 to a window 14 having a window frame 16 will now be described. Turning first to FIG. 7, a pair of adjacent windows 14, 14′ are illustrated attached to a building 50 or other structure by way of a window frame 16. Additionally, a glazing material 52 or other sealant is shown to provide an increased seal between the windows 14, 14′ and the window frame 16. It is to be appreciated that though two adjacent windows 14, 14′ are shown, it is to be appreciated that the following method can be used to attached various numbers of insulated window apparatuses 12 to various numbers of windows 14.

First, a stud 54 can be attached to the window frame 16. As shown, the stud 54 can include a generally elongate geometry having a shank 56, a first end 58 and a second end 60. Generally, the first end 58 is adapted to removably or non-removably attach to the window frame 16, while the shank 56 and/or the second end 60 are adapted to attach to the connector 40. Thus, the first end 58 can have various forms corresponding to various attachment methods. In one example, where the window frame 16 is formed of a metal material, the first end 58 can be adapted to be welded to the window frame 16 using various welding techniques. For example, the first end 58 can be welded to the window frame 16 using a capacitor discharge welding technique, wherein energy stored at a specific voltage in one or more capacitors is discharged through an ignition tip disposed on the first end 58, thereby creating an electric arc between the ignition tip and the window frame 16 to melt and join the first end 58 and window frame 16. The capacitor discharge welding technique can be accomplished by way of a specialized tool, which can also provide an electrical ground to the window frame 16. It is to be appreciated that various other welding techniques can also be used, such as arc welding, gas welding, resistance welding (including spot welding), energy beam welding, or solid-state welding (including ultrasonic welding). Other non-welding techniques can also be used, such as soldering or brazing. In other examples, where the window frame 16 includes metal or even wood (e.g., such as is commonly found in residential structures), the first end 58 can be adapted to removably or non-removably attach to the window frame 16 by way of screwing, nailing, clipping, punching, riveting, adhesives, tapes, various other fasteners, etc.

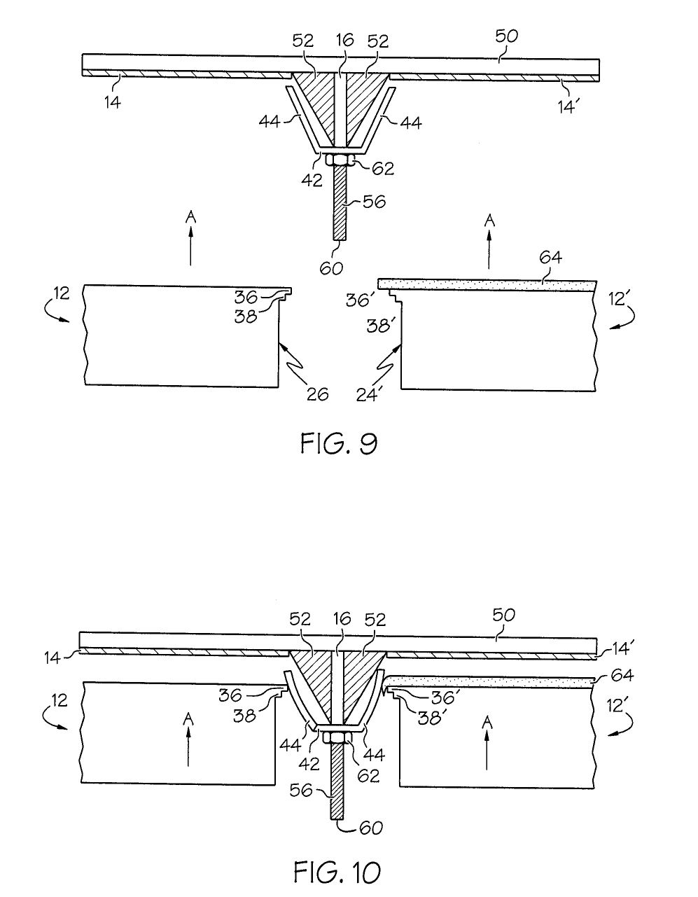

Turning now to FIG. 8, the stud 54, by way of the first end 58, is shown coupled to the window frame 16. Thus, the shank 56 and the second end 60 extend a distance away from the window frame 16. Next, the connector 40 is removably or non-removably attached to the stud 54. In one example, the second end 60 of the stud 54 is inserted through the hole 48 of the connector 40 (see FIG. 6) until the central frame 42 abuts the window frame 16. The shank 56 and the connector 40 can include various corresponding geometries and features for removably or non-removably attaching the connector 40 to the stud 54. In one example, the shank 56 can include male threads, while the hole 48 of the connector 40 can include corresponding female threads. Thus, the connector 40 can be threaded onto the stud 54. In addition or alternatively, a nut 62 (see FIG. 9) or the like can be used to retain the connector 40 onto the stud 54, with or without the described threaded connection between the connector 40 and the stud 54. In addition or alternatively, a pawl nut (not shown), internal-tooth lock washer (not shown), or the like can be used. It is to be appreciated that various other methods can also be used to retain the connector 40 on the stud 54, such as welding, soldering, brazing, adhesives, fasteners, plastic deformation of either or both of the connector 40 and/or the stud 54, etc. Thus, the central frame 42 of the connector 40 can be coupled to the window frame 16 and can be generally free from movement, while each of the arms 44 are permitted to resiliently pivot or flex relative to the central frame 42.

Turning now to FIGS. 9-11, each insulated window apparatus 12 can be attached to and retained against each window 14 via the connector 40. For example, an insulated window apparatus 12 is located in a covering relationship over the window 14 and adjacent to the window frame 16. Next, the arm 44 of the connector 40 is engaged with the lip(s) 36, 38 of the insulated window apparatus 12 to thereby retain it in abutment with the window 14. For example, as shown in FIG. 9, the insulated window apparatus 12 is moved towards the window 14 along the direction of arrow A. Next, as shown in FIG. 10, the first lip 36 strikes the arm 44 of the connector 40 and biases it inwards towards the glazing 52 until the apparatus body 28 is in abutment with the window 14. Next, as shown in FIG. 11, the arm 44 of the connector 40 resiliently springs outwards after the first lip 36 moves beyond the distal end 46 such that the distal end 46 locks against the lip(s) 36, 38 in a snap/click fastening arrangement. Thus, where only one lip 36 is used, the distal end 46 of the connector arm 44 rests solely against the lip 36. However, where a pair of lips 36, 38 is used, as shown, the distal end 46 of the connector arm 44 can rest against the stepped interface between the first and second lips 36, 38 to inhibit movement of the distal end 46 of the arm 44 and thereby inhibit inadvertent separation of the connector 40 from the window insulation apparatus 12. Further, each insulated window apparatus 12, 12′ can be removed and/or replaced by reversal of the aforedescribed process. For example, each arm 44 can be manually biased inwards towards the glazing 52 until the distal end 46 of

In addition or alternatively, as shown in FIGS. 9-11, the connector 40 can be located between a pair of windows 14 and can include a pair of resilient arms 44. Thus, a pair of insulated window apparatuses 12, 12′ can each be located in a covering relationship over separate, adjacent windows 14, 14′, and each apparatus 12, 12′ can separately engage one of the pair of resilient arms 44 to thereby simultaneously retain both of the insulated window apparatuses 12, 12′ in abutment with the respective windows 14, 14′. As a result, the number of connectors 40 required to retain a large number of insulated window apparatuses 12, 12′ can be reduced. Each arm 44 of the connector 40 can independently engage a respective window apparatus 12, 12′, such that each separate window apparatus 12, 12′ can be independently mounted, removed, reinstalled, etc. In addition or alternatively, each connector 40 can include one or more arms 44 for attachment to one or more windows.

Further still, each insulated window apparatus 12 can be used with an insulative member 64 to provide additional insulation or sealing with each window 14. For example, as shown in FIGS. 9-11, the right-hand insulated window apparatus 12 is illustrated mounted directly to the window 14 without an insulative member 64, while the left-hand insulated window apparatus 12′ is illustrated mounted indirectly to the window 14′ by way of an insulative member 64. Thus, none, some, or all of the insulated window apparatuses 12 can be used with an insulative member 64. Further, the insulative member 64 can be used independently of any internal insulation 32 located within the chamber 30 or recess.

Turning briefly back to FIGS. 2-4, the insulative member 64 can have a geometry generally similar to that of the insulated window apparatus 12. For example, as shown in FIG. 2, the insulative member 64 can have a generally rectilinear geometry. The insulative member 64 can be of similar size to the insulated window apparatus 12, or as shown, can even be larger so as to provide additional sealing around the outer perimeter of the apparatus body 28. For example, the edge 66 of the insulative member 64 can extend approximately ½″ beyond each edge of the apparatus body 28 (e.g., the outer edge of the lip 36), though various other smaller or greater lengths are also contemplated. For example, as shown in FIG. 3, the insulative member 64 can extend a third distance D3 from the chamber 30 or recess greater than the first or second distances D1, D2 of the lips 36, 38. Thus, where the insulative member 64 is larger than the apparatus body 28, it can have a larger outer perimeter than the outer perimeter of the apparatus body 28. It is to be appreciated that various other geometries, lengths, extensions, perimeters, etc. for the insulative member 64 are also contemplated.

The insulative member 64 can include various materials, such as foam, a trapped-air-pocket material (e.g., bubble-wrap or the like), fiberglass, fabric, plastic spacer, gels, etc. In addition or alternatively, the insulative member 64 can have various coatings, such as a reflective coating so as to aid in reflecting light and/or heat loss, though various other coatings are also contemplated. Further, because the insulative member 64 is captured between the insulated window apparatus 12′ and the window 14′, it can be beneficial to utilize a sheet-form insulative material or the like that is generally flexible and resilient so as to provide increased sealing. Additionally, although shown as generally uniform, the insulative member 64 can have various thicknesses and/or extension lengths, etc.

Turning back now to FIGS. 9-11, the insulative member 64 can be positioned against the rear surface of the insulated window apparatus 12′ before it is placed onto the window 14′. Additionally, as shown, the edge 66 of the insulative member 64 can extend a distance outwards from the edge of the lip 36′. Thus, as shown in FIG. 10, when the insulated window apparatus 12′ is retained in abutment with the window 14′, the insulative member 64 can be retained and/or compressed therebetween. Additionally, a portion of the edge 66 of the insulative member 64 can be compressed against the window 14′ and the glazing 52′, so as to provide an increased seal therebetween to inhibit air leakage and provide increased thermal efficiency. It is to be appreciated that various other configurations of the insulative member 64 can also be used to increase the sealing and/or thermal efficiency of the insulated window apparatuses 12′.

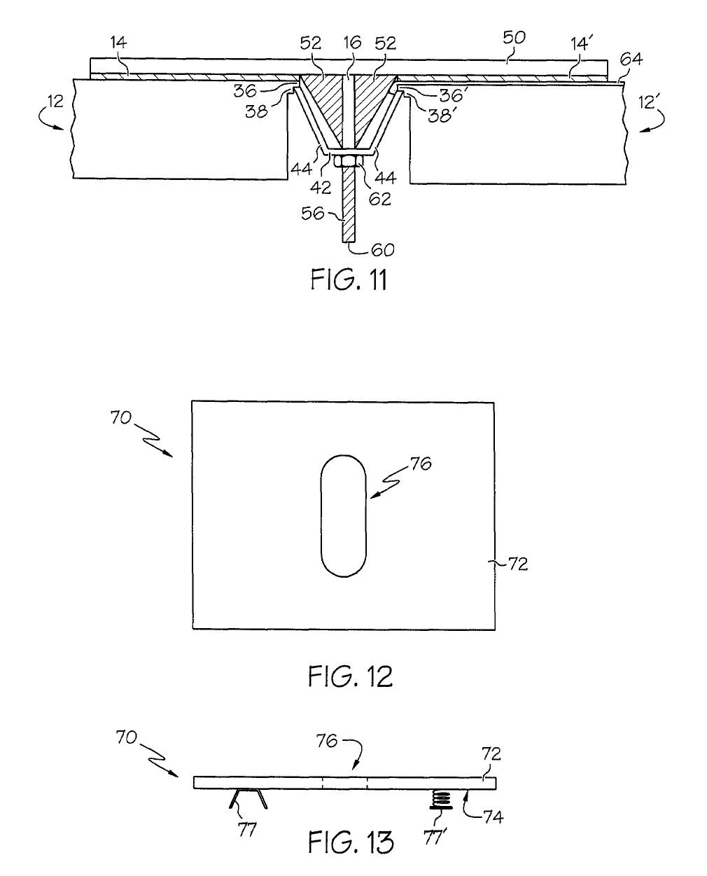

Turning now to FIGS. 12-13, another example alternative connector 70 will now be described. The resilient-arm connectors 40 described previously herein can be beneficial to secure the insulated window apparatuses 12 to a window frame 16 while maintaining a generally low-profile, unobtrusive visual appearance. However, because buildings are unique and have various constructions, the resilient arm connectors 40 may not always be convenient to use. For example, construction details, such as pipes, trusses, overhangs, etc. may inhibit or prevent usage of the resilient-arm connectors 40. In such situations, it can be beneficial to use an alternate connector 70.

As shown, the example connector 70 can include a plate 72 having a clamping face 74 adapted to apply a clamping or compressive force to the face surface 18 of the body 28. Though shown as having a generally rectilinear geometry, the connector 70 can have various other geometries, such as circular, triangular, elliptical, polygonal, irregular, etc. Additionally, though shown as having a generally uniform thickness, the connector 70 can also have non-uniform or varying thicknesses. In addition or alternatively, the plate 72 can include other features, such as a hole 76 extending therethrough for receiving a stud 54. The hole 76 can have various geometries, such as circular, square, triangular, rectangular, polygonal, irregular, etc. In one example, as shown, the hole 76 can have a generally elongated geometry to permit adjustability of the connector 70 along the length of the hole 76 and relative to one or more insulated window apparatuses 12.

Turning briefly back to FIG. 1, an example method of attaching an insulated window apparatus 12 to a window 14 by way of the example connector 70 is illustrated. The connector 70 is positioned such that a stud 54 can be received through the hole 76, and then the clamping face 74 is placed into abutment with the face surface 18 of the insulated window apparatus 12. Next, a fastener, such as a nut (e.g., similar to the nut 62 shown in FIGS. 9-11) or the like, is engaged with the stud 54 to thereby apply a clamping force to the connector 70, which will be translated to the face surface 18 of the insulated window apparatus 12. Various other fasteners can also be used, such as a spring clip, ratchet structure, adhesives, various mechanical fasteners, etc. Thus, the clamping force can be applied to the body 28 of the insulated window apparatus 12 via the connection between the connector 70 and the stud 54. It is to be appreciated that where an adjustable fastener, such as a nut, ratchet structure, or the like is used, the clamping force applied can be adjusted. In addition or alternatively, the connector 70 can further include resilient features 77 coupled to or formed therewith so as to apply a reactive force against the clamping force. The reactive force can provide a more assured connection between the connector 70 and the body 28, and/or can act to inhibit inadvertent loosening of the nut 62 in a fashion similar to a spring washer. In one example, the resilient features 77 can include one or more resilient arms. In another example, the resilient features 77′ can include various springs or the like. It is to be appreciated that conventional spring washers can also be used between the nut 62 an the connector 70.

As shown, the connector 70 can be used between a pair of insulated window apparatuses 12, 12′ that are each located in a covering relationship over separate, adjacent windows (hidden and not shown). Thus, the clamping face 74 (not shown in FIG. 1) of the connector 70 can separately engage and apply a clamping force to each of the insulated window apparatuses 12, 12′ (e.g., via the face surface 18, 18′) to thereby simultaneously retain both apparatuses 12, 12′ in abutment with the respective windows 14 (not shown). In another example, also as shown in FIG. 1, a single connector 70′ can also be adapted to only abut a single insulated window apparatus 12. Thus, as shown, the hole 76 can be oriented in an offset location, and the plate 72′ can extend only towards a single window apparatus 12′. In another example, as shown, a single connector 70″ could be adapted to apply a clamping force to four insulated window apparatuses 12 simultaneously. It is to be appreciated that it is to be appreciated that the connector 70, 70′, 70″ can be adapted to abut various numbers of insulated window apparatuses 12. Further, as shown, various insulated window apparatuses 12 can be retained on windows 14 using a single, multiple, or multiple combinations of types of connectors 40, 70.

In yet another example, any or all of the connectors 70 can be formed with or otherwise coupled to one or more of the insulated window apparatuses 12. For example, where an insulated window apparatus 12 is formed by way of an injection molding operation, a connector 70 can be formed therewith during the molding operation. As before, a fastener can be engaged with the stud 54 to thereby apply a clamping force to the connector 70, which will be translated to the body 28 of the insulated window apparatus 12. It is to be appreciated that the connector 70 can be adapted to retain only a single window apparatus 12, or even multiple window apparatuses 12. In addition or alternatively, multiple connectors 70 can be adapted to engage and/or interlock with each other to provide increased stability.

In addition or alternatively, any or all of the insulated window apparatuses 12 can be applied to the interior or even the exterior (or both) of a building or structure. Thus, as described herein, the insulated window apparatuses 12 can be coupled to an interior surface of a window 14, window frame 16, and/or other building structure. In another example, some or all of the insulated window apparatuses 12 can be applied to an exterior surface of a window 14, window frame 16, and/or other building structure. In addition or alternatively, additional safety structure can be applied to the insulated window apparatuses 12 to inhibit accidental detaching thereof. In one example, as shown in FIG. 1, one or more safety wires 78, lines, or the like can be used to inhibit accidental detaching of an insulated window apparatus 12. For example, where an insulated window apparatus 12 is coupled to an exterior surface of a window 14, the safety wires 78 can inhibit accidental detaching due to environmental factors, such as strong gusts of wind, rain, ice or snow damage, temperature fluctuations, etc.

It is to be appreciated that although described herein generally in terms of an industrial application, the insulated window apparatus 12 can also be applied in a similar manner to residential applications, such as homes or the like. For example, in residential homes, it can be common to find window frames 16 formed of wood. In such a case, the stud 54 and/or connectors 40, 70 can be adapted to interact with wood (e.g., screwing, nailing, adhesives, low-impact fasteners, etc.). In another example, the insulated window apparatus 12 can also be applied to portable applications, such as portable structures, automobiles, planes, trains, RV's, boats, etc.

In addition or alternatively, where an insulated window apparatus 12 is formed of a generally rigid, durable material (e.g., metal, plastic, etc.), it can be used in various impact resistant applications. For example, glass is a generally brittle material that generally cannot withstand impact loads. Thus, the insulated window apparatus 12 can be used in an environment that may be subject to impact loads to thereby protect an underlying glass window 14.

In addition or alternatively, though described herein as being coupled to a generally static window 14 and/or window frame 16, any or all of the structures described herein can be coupled to various other elements of a window, such as, for example, a casing, rail, stile, sash, etc. Even further still, any or all of the structures described herein can be adapted to be utilized on portions of a window that are moveable. Thus, in one example, an insulated window apparatus 12 can be adapted to be moveable with a window 14, such as for sliding, tilting, and/or pivoting movement. In such a case, the insulated window apparatus 12 may not have to be removed prior to subsequent movement of the window 14.

In addition or alternatively, though described herein as being as being coupled to a generally static window 14 and/or window frame 16, any or all of the structures described herein can be coupled to various other elements of a building, home, vehicle, etc. that may or may not include a window. In one example, the insulated window apparatus 12 can utilized merely as a decorative feature on a wall, ceiling or doorway that lacks windows. For example, where a wall, ceiling and/or doorway has an undesirable appearance, such as may be found in an industrial building having metal or concrete walls, the insulated window apparatus 12 can be coupled thereto to provide a more pleasing appearance, such as to provide the appearance of windows or the like. Alternatively, the insulated window apparatus 12 can include various decorative features (colors, patterns, indicia, surface features, artificial lighting, glass block effects, etc.) to increase the visual appearance of a wall, ceiling or doorway. The insulated window apparatus 12 can include insulation 32, 64, as described herein, or may be utilized without such insulation.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. An insulated window apparatus, including:
a face surface;
top, bottom, and opposed side surfaces formed with the face surface, each of the top, bottom, and opposed side surfaces being coupled to a portion of the face surface and to each other to define a chamber;
an insulative member; and
a lip coupled to at least one of the top, bottom, and opposed side surfaces, the lip extending away from the chamber.

2. The insulated window apparatus of claim 1, wherein the lip is adapted to engage a resilient arm of a connector for retaining the insulated window apparatus on a window.

3. The insulated window apparatus assembly of claim 1, wherein at least one of the face surface and the insulative member is formed of a light permeable material.

4. The insulated window apparatus assembly of claim 1, wherein the face surface, top surface, bottom surface, and opposed side surfaces are formed together by an injection molding operation.

5. The insulated window apparatus of claim 1, wherein the lip includes a pair of adjacent lips extending away from the chamber, a first of the pair of lips extending a first distance away from the recess, and a second of the pair of lips extending a second distance away from the recess, the first distance being greater than the second distance.

6. A method of assembling an insulated window apparatus to a window having a window frame, the method including the steps of:
providing an insulated window unit, including a face surface and top, bottom, and opposed side surfaces formed with the face surface, and a lip formed on at least one of the top, bottom, and opposed side surfaces;
providing a stud and a connector configured to be connected to the stud, the connector including a resilient arm;
coupling the stud to the window frame;
coupling the connector to the stud;
locating the insulated window unit in a covering relationship over the window and adjacent to the window frame; and
engaging the lip of the insulated window unit with the arm of the connector to thereby retain the insulated window apparatus in abutment with the window.

7. The method of claim 6, wherein the insulated window unit is formed of a light permeable material.

8. The method of claim 6, wherein the stud is attached to the window frame by a welding operation.

9. The method of claim 8, wherein the welding operation includes a capacitor discharge welding operation.

10. The method of claim 6, wherein the connector is removably connected to the stud.

11. The method of claim 6, wherein the connector includes a pair of resilient arms, the method further including the steps of providing a pair of insulated window units, locating each insulated window unit in a covering relationship over separate, adjacent windows, and engaging the pair of resilient arms with a lip of a separate one of the pair of insulated window units to thereby simultaneously retain both of the insulated window units in abutment with the respective windows.

12. The method of claim 6, further including the steps of providing an insulative member having an outer perimeter greater than an outer perimeter of the insulated window unit, locating the insulative member between the insulated window unit and the window and in a covering relationship over the window, such that a portion of the insulative member extends a distance beyond the lip of the insulated window unit to provide a seal between the insulated window unit and the window.

13. An insulated window apparatus assembly adapted for installation over a window having a window frame, including:
a body including a face surface and top, bottom, and opposed side surfaces coupled with the face surface to define a recess, the body having a first outer perimeter;
an insulative member having a second outer perimeter, the second outer perimeter being greater than the first outer perimeter;
a stud adapted to be coupled to a window frame; and
a connector adapted to be coupled to the stud and having securement means adapted to engage the body for retaining the body in abutment with the window.

14. The insulated window apparatus assembly of claim 13, wherein the body includes a lip formed on at least one of the top, bottom, and opposed side surfaces and extending away from the recess, and the securement means includes a resilient arm adapted to engage the lip.

15. The insulated window apparatus of claim 14, wherein the lip includes a pair of adjacent lips extending away from the recess, a first of the pair of lips extending a first distance away from the recess, and a second of the pair of lips extending a second distance away from the recess, the first distance being greater than the second distance.

16. The insulated window apparatus of claim 13, wherein the securement means includes a plate having a clamping face adapted to apply a clamping force to a face surface of the body.

17. The insulated window apparatus of claim 16, wherein the connector and plate are formed with the body, and the clamping force is applied to the body via the coupling between the connector and the stud.

18. The insulated window apparatus assembly of claim 13, wherein at least one of the face surface and the insulative member is formed of a light permeable material.

19. The insulated window apparatus assembly of claim 13, wherein the body is formed by an injection molding operation.

20. The insulated window apparatus assembly of claim 13, wherein the stud is attached to the window frame by a welding operation.

21. The insulated window apparatus assembly of claim 13, wherein the connector is removably connected to the stud.

22. The insulated window apparatus assembly of claim 13, wherein the connector includes a pair of resilient arms, each arm being adapted to engage one of a pair of adjacent bodies to simultaneously retain each of the bodies in abutment with a pair of adjacent windows.
